(19) United States
(12) Patent Application Publication
(10) Pub. No.: US 2018/0343879 A1
(43) Pub. Date: Dec. 6, 2018

(54) METHOD FOR PRODUCING DAIRY PRODUCTS WITH THE ADDITION OF ESSENTIAL OILS

(71) Applicant: THEODOROS KOURELLAS, GREVENON-MEGAROU (GR)

(72) Inventor: THEODOROS KOURELLAS, GREVENON-MEGAROU (GR)

(21) Appl. No.: 15/527,757

(22) PCT Filed: May 22, 2015
(86) PCT No.: PCT/GR2015/000026

§ 371 Date: May 18, 2017

(30) Foreign Application Priority Data
Nov. 25, 2014 (GR) 20140100588

(51) Int. Cl. A23C 9/13; A23C 19/055; A23C 9/156; A23L 27/12

(52) U.S. Cl. CPC A23C 9/1315; A23L 27/12; A23C 9/156; A23C 19/055

(57) ABSTRACT

The invention relates to a method for producing dairy products with the addition of essential oils. The products obtained have features that improve the defense of the human organism. For the preparation of the products, milk is pasteurized, culture is added and the product is fermented appropriately. Thereafter, it is strained, as required, and the selected essential oils are added. If the product to be obtained is cheese, then curing of the product is effected as required. In an alternative embodiment of the method, the essential oils may be added in the starting material, immediately after milk pasteurization.

### FIELD OF THE INVENTION

The invention relates to the field of methods for producing dairy products with the addition of essential oils, in order to improve the defense function of the human organism.

### BACKGROUND OF THE INVENTION

The method for producing dairy products with the addition of essential oils as proposed in the present invention, as well as the products obtained by the present method have not been disclosed in the prior art.

Our era is characterized by a technological and medical progress in various levels. Compared to previous centuries, human has managed to increase life expectancy, improving the working and living conditions, while in parallel various diseases which were previously debilitating or even life-threatening have been successfully treated. It is however established that the rhythms of life, as well as the associated demands, frequently lead humans to limiting conditions, forcing them to consume food supplements and vitamin formulations of ambiguous quality; in an effort to enhance the natural defense of the organism.

It has been scientifically demonstrated that food supplements cannot be substitute for a balance nutrition, while the uptake of nutritional ingredients from the organism may be effected through the food and through formulations rich in a nutritional ingredient.

Essential oils are volatile substances that are isolated by means of a process, such as distillation, from an aromatic plant of a specific plant species. Essential oils are of plant origin and are characterized by a characteristic odour and a trend to hydrolysis. Essential oils are liquids at room temperature, however they evaporate at boiling temperature, between 50 and 320° C. Due to their volatility they have a characteristic odour. It has been further demonstrated that they exhibit various therapeutic properties, since they show antiseptic, antibacterial, anti-viral, anti-fungal, would-healing, analgesic, anti-inflammatory antitoxic properties. Furthermore, they cause hyperemia, relax and restrict the muscles, while it has been experimentally proven that they may exhibit anti-depressive, spasmolytic, digestive, diuretic, immunostimulant, hormonal, expectorant and deodorizing properties. Research has shown that basil is a sweet, fragrant oil with sedative and stimulating results. It is excellent for humans that are tired due to work while it provides mental clarity and is a very good nerve stimulant. It also acts on muscle spasms and insomnia. On the other side, rosemary has refreshing and stimulant properties on the circulatory system and memory. It is excellent agent for problems related to the scalp and aids in arthritis and rheumatism.

Additionally, it is known that dairy products contain proteins of high nutritional value, since they contain sufficient quantities of all the essential amino acids for the human organism. Apart from the role of the proteins of the dairy products on tissue structure, recent studies have shown that they have; biological functions on various systems of the organism, such as the immune system and the nerve system, the circulatory system, reducing blood pressure, the gastrointestinal system, reinforcing calcium uptake, and the cellular system, acting as antibacterial agent.

It is an object of the present invention to address the disadvantages and deficiencies of the prior art, and to propose a method for producing dairy products with the addition of essential oils.

A further object of the present invention is to provide a method for producing dairy products that will increase and improve the organoleptic properties of the products.

A further object of the present invention is to provide a method for producing dairy products that is suitable to be applied for the production of every kind of diary products, including, but not limited to, milk, yogurt, cheese, chocolate milk, milk beverages, yogurt with fruits as well as fermented dairy products.

A further object of the present invention is to provide a method for producing dairy products which allows addition of essential oils both to the starting material and to the final product.

A further object of the present invention is to provide a method for producing dairy products wherein the final product comprises bioactive ingredients that protect human cells, such as those exposed to oxidative stress conditions.

An object of the present invention is to provide dairy products in which pure herbs are added, further reinforcing the organoleptic and bioactive features of the final products.

These and further objects, features and advantages of the invention will be fully apparent by the following detailed description.

The invention will be fully understood by the skilled in the art with reference to exemplary embodiments, in which the method is presented in an exemplary, non-limiting way.

### DETAILED DESCRIPTION OF A PREFERRED EMBODIMENT

The present invention aims at providing a method for producing dairy products with the addition of essential oils therein, thereby reinforcing and improving their properties. According to the method described in detail in below, essential oils may be added both to fresh, pasteurized milk and to yogurt, cheese, of any kind, as well as to any kind of milk beverages and fermented milk products. As it will be apparent from the detailed description of the method, this addition may be effected both to the final product and before its packaging, and to the starting material, without any significant differences in the final product.

Cheese production with the addition of essential oils in the final product, whether yellow cheese or white, hard or semi-hard cheese or whey, is performed with the initial pasteurization of the milk at 72° C. for a suitable time period. The common practice in the field of cheese products is a time period of ca. 15 seconds for the specific procedure. Subsequently, during production, an bacterial culture is added in the milk, in a ratio of 1 sachet per 1000 liters of milk. The mixture is left to coagulate and fermented for a time period equal to 2 hours, then is strained and in the brine the desired essential oils are added in a ratio of ca. 2% of the total brine quantity. After completion of ca. 24 hours, the cheese is placed in containers with the brine and left to cure for at least 60 days. As it is apparent, the curing period may be longer, depending on the type of cheese produced.

In an alternative embodiment of the invention, and given that the essential oils do not affect the cheese production procedure, these may be added in the starting material, immediately after the milk pasteurization and before the addition of the bacterial culture. The proportion of the added essential oils does not differ in this case either, and exemplarily it amounts to 2% of the total.

In the yogurt production procedure, as well in the production procedure for products such as yogurt with fruits and/or fermented milk products, the production method with the addition of essential oils in the final step includes milk pasteurization at 72° C., for a suitable time period, followed by culture addition, corresponding to 1 sachet per 1000 liters of milk. Thereafter, the product is fermented for a time period equal to 4 hours, without being limited to that, and then is strained, as required, and the essential oils are added. The proportion of the essential oils is exemplarily 2%, without being limited to that. Finally, the product is packaged for use by consumers.

In an alternative embodiment of the method for producing the said products, the addition of the essential oils may be effected in the starting material, before the addition of the bacterial culture, without needing to change the proportions or the steps.

Furthermore, as regards the production of fresh or chocolate milk with the addition of essential oils, the method comprises milk pasteurization at the suitable temperature for the necessary time period, and then the addition of the essential oils, before packaging. In an exemplary, non-limiting embodiment, pasteurization lasts for 15 seconds at 72° C., before adding 2% essential oils and packaging of the product.

It is noted that the essential oils used are derived from oregano, basil and rosemary, however any other suitable essential oil, or a combination thereof may be added, depending on the desires and the individual demands of the consumers.

Finally, in an alternative embodiment of the invention, the method for producing dairy products with the addition of essential oils may be further refined with the use of pure herbs in the final step of the method, further reinforcing the organoleptic and bioactive features of the final products. The added herbs may match with the respective essential oils, such as oregano, basil and rosemary, however any combination with the use of other herbs not mentioned in the present description may be provided.

It should be noted that the description of the invention was made with reference to exemplary non-limiting embodiment. Thus, any variation or modification as regards the materials used, the steps of the method, the production procedure and the respective time period of each step, as long as they do not constitute a new inventive step and do not contribute to the technical progress of the already known state of the art, are encompassed in the scope of the present invention.

1. Method for producing dairy products with the addition of essential oils, characterized in that for the production of any kind of cheese, milk is pasteurized, essential oils are added, culture is added and the product coagulates, before being placed in containers with brine, left to cure for the necessary time period and packaged.

2. Method for producing dairy products with the addition of essential oils, according to claim 1, characterized in that the essential oils are added before being placed in the containers with brine.

3. Method for producing dairy products with the addition of essential oils, according to claim 1, characterized in that pure herbs are added before packaging.
